(19) United States
(12) Patent Application Publication
(10) Pub. No.: US 2007/0262268 A1
(43) Pub. Date: Nov. 15, 2007

(54) Method for imaging a pattern onto a target portion of a substrate

(75) Inventors: Martin Jules Marie-Emile De Nivelle, Eindhoven (NL); Ralph Brinkhof, Eindhoven (NL); Jozef Cornelus Antonius Roijers, Eindoven (NL)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: ASML Netherlands B.V., Veldhoven (NL)

(21) Appl. No.: 11/412,114

(22) Filed: Apr. 27, 2006

(51) Int. Cl. G21G 5/00

(52) U.S. Cl. 250/492.1

(57) ABSTRACT

A method for imaging a pattern onto a target portion of a substrate, comprises: providing a projection system configured to project a patterned radiation beam onto a target portion of a substrate,providing a substrate positioned on a substrate table, providing a level sensor arranged to provide level sensor readings being a measure of the topology of the substrate. The method further comprises:providing level sensor readings by scanning the target portion with the level sensor, while synchronously,imaging the pattern onto the target portion by scanning the target portion of the substrate with the patterned radiation beam, while positioning the substrate table with respect to the radiation beam based on the level sensor readings, wherein the level sensor readings are adjusted based on previously determined average level sensor readings.

### FIELD

The present invention relates to a method for imaging a pattern onto a target portion of a substrate. The invention further relates to a method for determining average level sensor readings and to a lithographic apparatus for imaging a pattern onto a target portion of a substrate

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon substrate). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

In order to ensure a sharp image of the pattern being generated at the target portion, the layer of radiation-sensitive material (resist) provided on the substrate is positioned in a focal plane of a projection system of the lithographic apparatus imaging the pattern. This positioning (leveling) involves measuring the height and shape of the target portion and based on these measurements, positioning the target portion with respect to the projection system.

On scanners with a single substrate stage on-the-fly levelling is the common levelling method. Such an on-the-fly measurement may involve measuring the height and tilt of the target portion using a level sensor, scanning the target portion with a plurality of level sensors spots. This will be explained in more detail below.

The level sensors scanning the target portion are followed in real-time by an exposure slit performing the actual exposure. The measurements of the level sensor are fed in to a feedback loop, positioning a substrate table on which the substrate is positioned in real-time.

It will be understood that off-line substrate topology measurement for levelling would severely reduce throughput on these systems. However, on-the-fly leveling comes with certain problems.

(1) On scanners on-the-fly levelling comes with delays between level sensor measurement and substrate stage movement. These delays are compensated by locating level sensor spots in front of the exposure slit, or by predicting substrate topology by forward extrapolation from measured height and tilt close to or within the exposure slit.

If the scan speed is increased to improve throughput, the spots have to be positioned further ahead of the slit to cope with the delays. This has the disadvantage that the total scan length for each exposure field has to be increased, which results in throughput loss. Increasing the forward extrapolation distance to match the delays at increased scan speed, increases the possible leveling errors.

(2) Due to the topology of the substrate or target portion, each level sensor spot measures different height differences with respect to a nominal focus plane. As a result, near the edge of a substrate where spots have to be switched-off, jumps in the levelled height and tilt (i.e. focus errors) will occur.

(3) Back end (metal) layers are characterized by non-critical CD and a die topology with large height steps. The best way of levelling such a layer is along a smooth plane, ignoring device topology. The active on-the-fly levelling of a scanner attempts to follow the device topology, which leads to a reduction of usable depth of focus.

With improving substrate flatness, and the decreasing depth of focus related with the decreasing CD, the product topology becomes more relevant for leveling.

### SUMMARY

In one embodiment a method for imaging a pattern onto a target portion of a substrate, the method comprises:

providing a projection system configured to project a patterned radiation beam onto a target portion of a substrate,

providing a substrate positioned on a substrate table, the substrate table being arranged to be positioned with respect to the radiation beam,

providing a level sensor arranged to provide level sensor readings being a measure of the topology of the substrate at one or more positions within the target portion, the method further comprising: providing level sensor readings by scanning the target portion with the level sensor, while synchronously,imaging the pattern onto the target portion by scanning the target portion of the substrate with the patterned radiation beam, while positioning the substrate table with respect to the radiation beam based on the level sensor readings, wherein

the level sensor readings are adjusted based on previously determined average level sensor readings.

The substrate table may be positioned with respect to the radiation beam in order to position the substrate substantially in a focal plane of the projection system.

According to an embodiment, the level sensor readings are adjusted by subtracting the previously determined average level sensor readings from the level sensor readings.

According to an aspect , there is provided a method for determining average level sensor readings, the method comprising:

providing one or more substrate positioned on a substrate table,

providing a level sensor arranged to provide level sensor readings being a measure of the topology of the substrate at one or more positions within a measurement area on the one or more substrates,

the method further comprising:

providing level sensor readings by scanning at least two measurement areas with the level sensor, and

computing average level sensor readings by averaging the level sensor readings from corresponding relative positions within different measurement areas.

According to an aspect, there is provided a lithographic apparatus for imaging a pattern onto a target portion of a substrate, the lithographic apparatus comprising:

a projection system configured to project a patterned radiation beam onto a target portion of a substrate,

a substrate table constructed to hold the substrate, the substrate table being arranged to be positioned with respect to the radiation beam, and

a level sensor arranged to provide level sensor readings being a measure of the topology of the substrate at least at one or more positions within the target portion, the system being arranged to provide level sensor readings by scanning the target portion with the level sensor, while synchronously imaging the pattern onto the target portion by scanning the target portion of the substrate with the patterned radiation beam, while positioning the substrate table with respect to the projection beam based on the level sensor readings, wherein the level sensor readings are adjusted based on previously determined average level sensor readings.

According to another aspect, there is provided a lithographic apparatus comprising:

a substrate table constructed to hold a substrate; and

a level sensor arranged to provide level sensor readings being a measure of the topology of the substrate at one or more positions within a measurement area on the substrate, the lithographic apparatus further being arranged to:

provide level sensor readings by scanning at least two measurement areas with the level sensor, and compute average level sensor readings by averaging the level sensor readings from corresponding relative positions within different measurement areas.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts a lithographic apparatus according to an embodiment;

FIG. 2 schematically depicts a part of the measurement station region of the lithographic projection apparatus, including a level sensor;

FIG. 3 schematically depicts a substrate according to an embodiment,

FIG. 4 schematically depicts a flow chart according to an embodiment,

FIG. 5 schematically depicts a substrate according to a further embodiment,

FIG. 6 schematically depicts a flow chart according to a further embodiment,

FIG. 7a and 7b schematically depict leveling profiles,

FIGS. 8a and 8b schematically depict exposure scans,

FIG. 9 schematically depicts an exposure scan,

FIG. 10 schematically depicts a flow chart according to a further embodiment,

FIG. 11 schematically depicts a flow chart according to a further embodiment and

FIG. 12 schematically depicts a flow chart according to a further embodiment.

### DETAILED DESCRIPTION

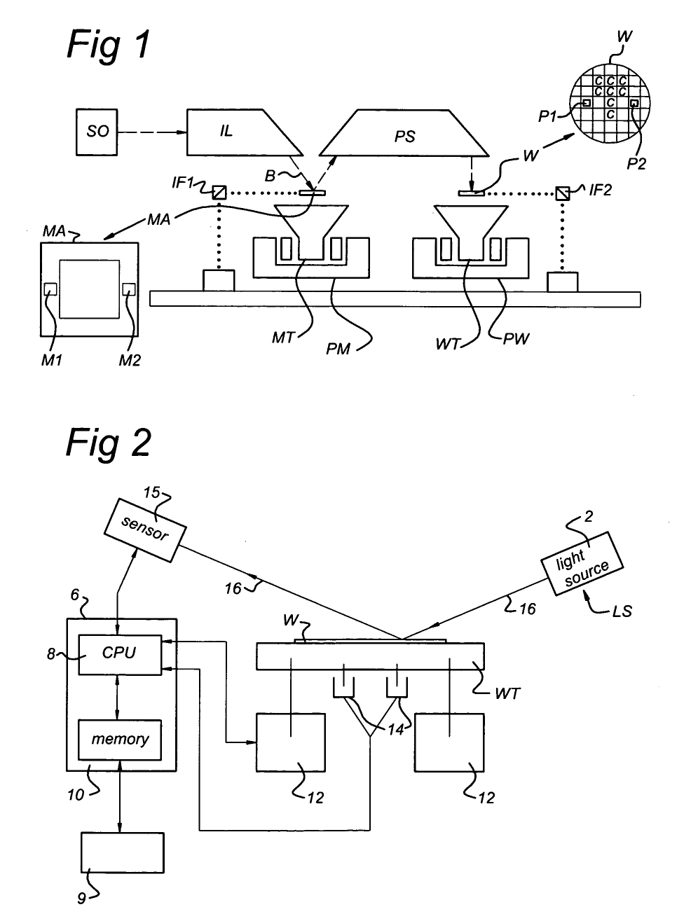

FIG. 1 schematically depicts a lithographic apparatus according to one embodiment of the invention. The apparatus comprises:

an illumination system (illuminator) IL configured to condition a radiation beam B (e.g. UV radiation or EUV radiation).

a support structure (e.g. a mask table) MT constructed to support a patterning device (e.g. a mask) MA and connected to a first positioner PM configured to accurately position the patterning device in accordance with certain parameters;

a substrate table (e.g. a wafer table) WT constructed to hold a substrate (e.g. a resist-coated substrate) W and connected to a second positioner PW configured to accurately position the substrate in accordance with certain parameters; and

a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a mariner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory actions may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

In FIG. 2, a part of the measurement station region of the lithographic projection apparatus is shown. The substrate W is held on the substrate table WT. The substrate table WT is connected to actuators 12. These actuators 12 are connected to a control device 6 with a processor (CPU) 8 and a memory 10. The processor 8 further receives information from position sensors 14 measuring the actual position of the substrate table WT or substrate table holder for instance by electric (capacitive, inductive) or optical, e.g. interferometric (as shown in FIG. 1) means. The processor 8 also receives input from a level sensor LS which measures the height and/or tilt information from the substrate W. Preferably, the control device 6 is connected to a reporting system 9, which may comprise a PC or a printer or any other registration or display device.

The level sensor LS may be, for example, an optical sensor; alternatively, a pneumatic or capacitive sensor (for example) is conceivable. A possible form of sensor is an optical sensor making use of Moiré patterns formed between the image of a projection grating reflected by the substrate surface and a fixed detection grating as described in U.S. Pat. No. 5,191,200. The level sensor LS should preferably measure the vertical position of one or more very small areas of the substrate surface. The LS shown in FIG. 2, comprises a light source 2 for producing a light beam 16, projection optics (not shown) for projecting the light beam 16 onto the substrate W, detection optics (not shown) and a detector 15. The detector 15 generates a height dependent signal, which is fed to the processor 8. The processor 8 is arranged to process the height information and control the substrate table WT movements.

The level sensor LS as shown in FIG. 2 may be applied in a multi stage lithographic apparatus or in a single stage lithographic projection apparatus.

The level sensing method uses at least one sensing area and measures the average height of a small area, referred to as a spot or level sensor spot. Depending on the position of the spot on the substrate area, a selection mechanism selects the spot or spots, which are applicable to derive height and/or tilt information from a measured target area.

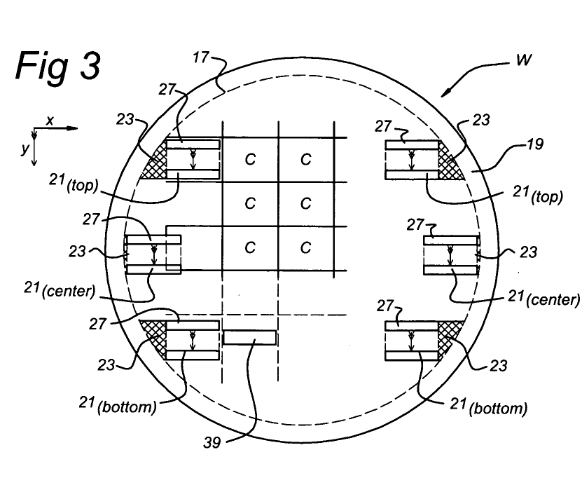

The principles of on-the-fly measurement will now be explained in more detail referring to FIG. 3.

In FIG. 3, the target areas are indicated with reference numeral C. In this specific case the level sensor LS has 8 spots which have to be measured on a substrate W in order to be able to determine the local height and tilt of an illuminated part of the target area C and to achieve sufficient averaging over the illuminated part of the target area C. Of course, level sensors with an other number of spots may be applied instead.

Further shown in FIG. 3 is a slit shaped area that is briefly referred to as slit 39. The slit 39 is the area illuminated during imaging in successive target areas C during scanning. In the scanning process, the slit 39 moves over the substrate surface in the y direction several times in series next to one another until the entire substrate surface is covered by images of the reticle or mask MA, as is known to a person skilled in the art. The slit 39 is shaped as a rectangle. According to FIG. 3, the length dimension of the slit 39 in the x direction is equal to the length in the x direction of a target area C. It will however be understood by a person skilled in the art that the length dimension of slit 39 may also be smaller or bigger with respect to the length in the x direction of a target area C. The width (along the y direction) of the slit 39 is much smaller than its length.

FIG. 3 also shows level scan areas 21 used by the level sensor LS to derive height and tilt data at the edge of the substrate W. A level sensor spot area, 27 is schematically indicated with reference number 27. The level sensor spot area 27 is scanned over the substrate surface along a predetermined path in the exposure direction y as indicated with an arrow.

Referring also to FIG. 2, during the scanning motion while exposing, moving the substrate W with respect to the focal plane, the substrate table WT is controlled by the actuators 12 driven by the CPU 8.

The actuators 12 controlled by the control device 6, are used to adjust the position of the substrate table WT in height and tilt, and hence the substrate 11, to ensure that the substrate W is in the focal plane during imaging, preventing defocus. One way to determine the required amount of position adjustment is described in U.S. Pat. No. 5,191,200.

By defocus is meant in what way the substrate W deviates from the focal plane of the projection beam PB of radiation. In normal operation, the level sensor LS measures heights, the vertical position of the substrate surface at multiple points, by means of multiple sensing areas (spots). The height readings of the spots are fed to the CPU 8, which uses these height values to derive an average height for the illuminated target area C to be positioned. If it is possible, e.g. from multiple height readings at different x and y positions of the illuminated target area, a desired height and tilt at which the substrate 11 should be positioned could be derived. The desired height and tilt of the substrate 11 is then provided by the CPU 8 by controlling the height and tilt of the substrate table WT by activating the actuators 12. In this way, a closed loop control mechanism to position the actual illuminated part of the target area C in the focal plane is achieved. During the exposure scan, the target area's illuminated part is continuously positioned in the focal plane by height readings supplied by the level sensor spot covering the slit shape exposure area.

According to a further embodiment the leveling process is done in another manner, as will be explained below. According to the embodiments described below, during on-the-fly leveling, i.e. performing leveling measurements during exposure, the leveling measurements are corrected for a previously obtained average topology of a target portion or exposure area.

### Embodiment 1

According to an embodiment, before exposure, the topology of a number of measurement areas is measured on a first substrate W of a batch of substrates W by performing a number of measurement scans with the level sensor LS. The number of measurements may comprise 10 measurements, but may be any number of measurements.

The topology of the measurement areas may be measured using only the first substrate W of a batch of substrates W in order to minimize time needed to perform these measurements. Also, it is assumed that the topology of the substrate W is sufficiently constant within one batch. However, it will be understood that according to other embodiments , a number of measurement areas from more than one substrate W may be measured.

Based on the performed measurements, information is determined that may be used during the actual leveling during exposure.

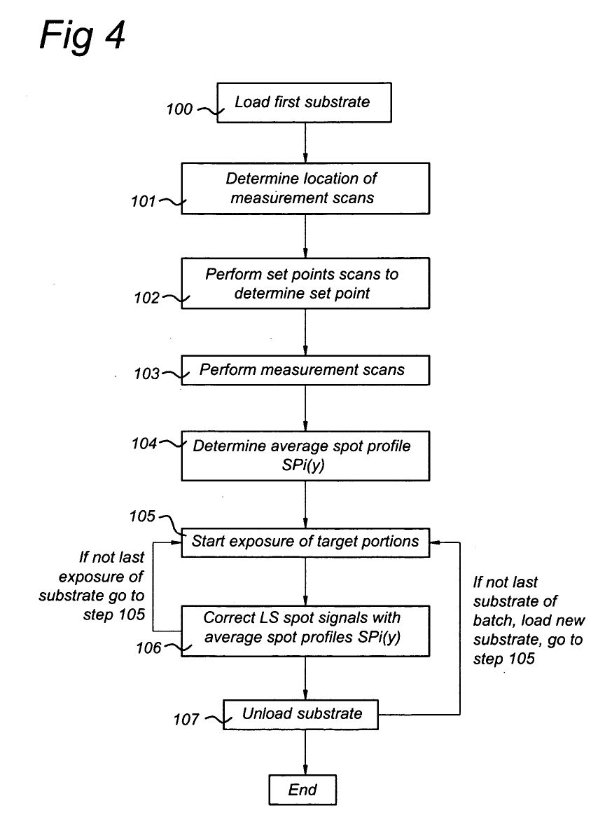

In FIG. 4, a flow chart according to an embodiment is shown to measure and use average spot profiles. It will be understood that the flow charts shown in this text may all be performed by a processor, such as processor 8 shown in FIG. 2. In order to do so, suitable program instructions, readable and executable by the processor 8 may be stored in the memory 10.

In a first action 100, a first substrate W is loaded on a substrate table WT and positioned in the measurement range of the level sensor LS.

In a next action 101, the location of the measurement scans are determined possibly taking into account a selection of the following criteria:

(1) the measurement areas may match the layout of the target portions C on the substrate W,

(2) the measurements areas may be on the area of the substrate W where all level sensor spots are valid, i.e. not near the edge of the substrate W,

(3) the scans may be performed on different measurement areas in order to get the best estimate for the average measurement area topology, and

(4) the scans may be located as close as possible to the centre of the substrate W because there the substrate W will generally be the most flat.

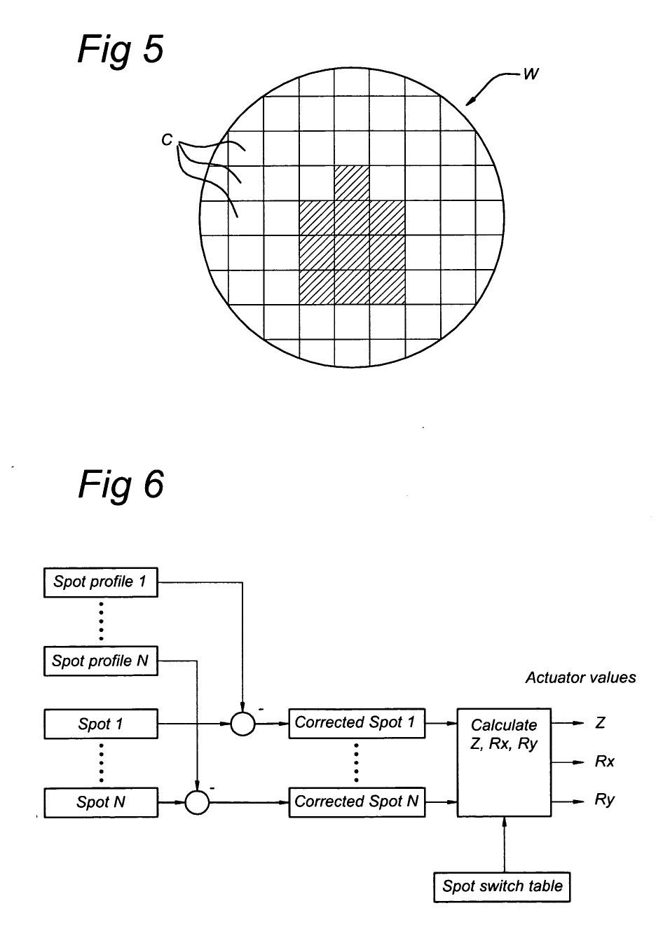

An example of a set of measurement locations is given in FIG. 5 indicated by the hatched target portions C. According to the example of FIG. 5, the selected measurement areas fulfill all 4 criteria specified above.

Before executing the actual measurement scans, first an action 102 is performed, in which so-called set point scans are performed to determine set points.

In order to have the most accurate level sensor measurements it is preferable that during measurement scans the substrate table WT is at the same height and tilt as during the actual exposure. Therefore, in action 102, so called set point scans are performed. With these set point scans the optimal path of the substrate table WT, the so-called set point, is determined that may be followed during the measurement scans. These set point scans are performed under closed loop control. This means that during the scan the system controls the substrate table WT so that the substrate surface covered by the level sensor spots is substantially in the focal plane. Level sensor readings and substrate table positions, as measured by the sensors, are stored in the memory 10 during the scans. Based on these readings the optimal path for the measurement scans, as performed in action 103, is determined.

Thus, according to an embodiment, before providing level sensor readings by scanning at least one measurement area with the level sensor, set points are determined by performing set point scans.

In one embodiment the optimal height path of the substrate table WT is a straight line profile determined by performing a line fit though the measured substrate shape. The optimal tilt may be a constant value equal to the average of the tilt of the substrate during the scan. In this way the substrate table path follows the global substrate shape.

In an action 103, actual measurements scans are performed according to the set points determined in action 102. During this scan the level sensor readings for each individual level sensor spot are stored in memory 10. Because the substrate table WT follows the global substrate shape the readings of the level sensor are mainly caused by the local device topology.

In action 104, the results of the different measurement scans are averaged for each level sensor spot i and each grid point, to reduce noise and difference in the shape of the underlying substrate W between the different measurement locations. The average topology of a measurement location (e.g. a target portion C) is calculated by adding the height of a particular point (yk) within a measurement scan k, (where (yk) indicates a local co-ordinate within the measurement scan), to the height of the corresponding points (yk) in the other measurement scans k, with k=1, 2, . . . N wherein N is equal to the number of measurement scans (e.g. 10). This is done for all points within the measurement scans. Then, for all the points (yk) within the measurement scans, the result of the addition is divided by the number of scans, i.e. N. The result is an average topology of the measurement locations, for instance a target portion C. According to this embodiment the average topology is calculated separately for each individual level sensor spot i resulting in so called average spot profiles SPi(y).

The resulting average topology may be assumed valid during an entire batch, since the systematic (design) average topology is assumed to be the same for all the substrates W of a batch. According to different embodiments, the resulting average topology may be assumed valid for any predetermined number of substrates W, for instance for more than one batch or only a portion of a batch.

According to an embodiment this average topology may be used during exposure to follow the global substrates shape as good as possible, while ignoring the local substrate topology completely. This is now possible, since the average local substrate topology is known before exposure is started. Therefore, the level sensor readings during the exposure can be corrected based on the determined average topology, resulting in level sensor readings only representing the global substrate topology, while ignoring the local topology, for instance determined by previously applied patterns and lithographic processing actions, such as development and etching.

In a next action 105, the actual exposure of the substrate W is started, for instance, by moving to a first exposure field or target portion C. In a next action 106, during exposure scans, the level sensor signal is corrected for the average topology determined in action 104. This way the systematic topology is ignored and the global substrate shape may be taken into account.

This is explained in more detail in FIG. 6. In case the average topology wouldn't be used or wouldn't be available, the readings of the level sensor spots would be used directly to calculate the height and tilt values for the actuators 12. In this case, the average spot profiles are used and the corresponding value in the average spot profile is subtracted from the level sensor signal as measured during exposure.

FIG. 6 shows that the N average spot profiles as determined in action 104 are subtracted from the respective N spot readings of the level sensor LS, resulting in N corrected level sensor spot values. The level sensor spot measurements are thus corrected for the average topology and representing the global substrate shape.

There is not always a one-to-one match between the measured level sensor spot signal and the average spot profile SPi(y), i.e. the measured level sensor spot signal and the average spot profile SPi(y) are not always determined for the same position within the substrate W. Therefore, the corresponding average spot profile value may be taken from a grid point of the average spot profile closest to the position of the level sensor measurement during the exposure scan (where y indicates the local die coordinate).

Based on these corrected level sensor spot values, an appropriate position and orientation of the substrate table WT is determined, in order to achieve an optimal focus. The appropriate position of the substrate table WT is determined using conventional techniques, known to a skilled person. These optimal position and orientation may be expressed in a z-value, representing the height of the substrate table WT in a direction substantially perpendicular to the projection beam PB of radiation and a tilt Rx and Ry about an x and y axis, being substantially perpendicular with respect to the z-axis and being substantially perpendicular with respect to each other.

In the embodiment described above, the value that is subtracted from the level sensor spot signal is simply the average spot profile SPi(y), as determined in action 104, that has the closest local y coordinate. However, according to an alternative embodiment, the value that is subtracted from the level sensor spot signal is obtained by interpolation or extrapolation of the available values of the average spot profile SPi(y). For instance, the value to be subtracted may be obtained by interpolation of two average spot profile values, where one has a y coordinate higher and the other has a y coordinate smaller than the y coordinate of the level sensor spot signal obtained during exposure.

Thus, according to an embodiment, the previously determined average level sensor readings comprise average spot profiles of the topology of the substrate along a path substantially in the direction of scanning the target portion with the patterned beam.

According to an embodiment, the adjustment of the level sensor readings based on previously determined average level sensor readings is done by using previously determined average level sensor readings being valid for a position within the target portion being close to the position the level sensor readings is valid for, for instance by using an average spot profile SPi(y) having an y coordinate being relatively close to the y coordinate of the level sensor reading that is to be adjusted.

According to a further embodiment, the adjustment of the level sensor readings based on previously determined average level sensor readings is done by using an interpolation of at least two previously determined average level sensor readings. These at least two previously determined average level sensor readings may be close (in the y direction) with respect to the level sensor reading that is to be adjusted. These at least two previously determined average level sensor readings may be both on opposite sides (in the y direction) with respect to the level sensor reading that is to be adjusted.

Referring again to FIG. 4, after action 106 has been executed, the next exposure field or target portion C is exposed. So, as long as the exposed target portion C is not the last target portion C of the substrate W, the process returns to action 105 to expose a next target portion C. In case the exposed target portion C is the last target portion C, the substrate W is unloaded in an action 107.

As long as the substrate W is not the last substrate of the batch or the predetermined number of substrates W that average topology is assumed valid for, after action 107, a next substrate W is loaded and the process returns to action 105. In case the substrate W is the last substrate of the batch or the predetermined number of substrates W that average topology is assumed valid for, the process ends.

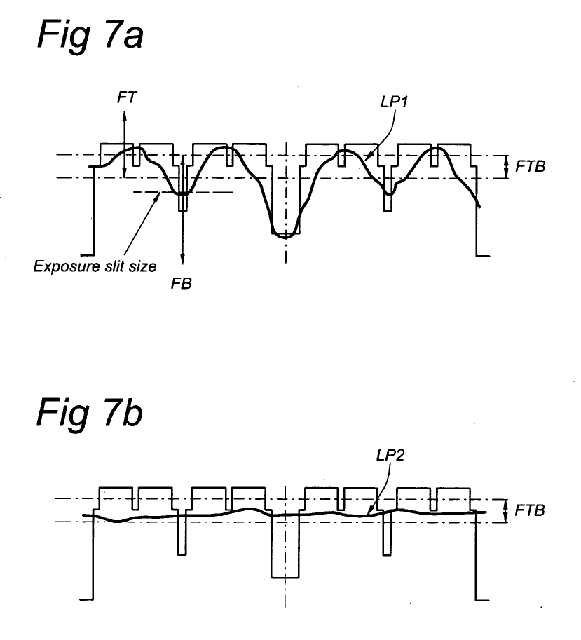

The advantage of the embodiments described above is explained with reference to FIGS. 7a and 7b.

FIG. 7a shows an example of a topology of, for instance, a target portion C. The topology comprises a pattern having relatively small height variations (top pattern), except for a few small trenches (bottom pattern), that are relatively low with respect to the top pattern. The top pattern has a focus range or depth of focus indicated with arrow FT and the bottom pattern has a focus range or depth of focus indicated with arrow FB. It can be seen that both focus ranges FT and FB are partially overlapping. This overlapping focus range is indicated with arrow FTB. When the focus plane is located within this overlapping focus range, both the top and bottom pattern of the device are in focus.

According to prior art on-the-fly leveling, the level sensor spots measure the height of the topology just before the exposure slit, as explained above. FIG. 7a also shows the size of the exposure slit. This situation results in a leveling profile indicated in FIG. 7a with the curved line LP1.

As a result of the topology the leveling profile LP1 shows large deviations. Because of the size of the exposure slit these deviations result in the outer part of the exposure slit to be out of focus.

FIG. 7b shows the same topology but with a leveling profile LP2 that is the result of the leveling according to the embodiments described above. Because the level sensor readings are corrected for the average spot profiles (i.e. the average topology) the resulting profile is much more flat and stays within the overlapping focus range FTB. As a result the entire image is in focus.

Another advantage as implemented in these embodiments is that due to the fact that the high frequent product topology is effectively removed from the level sensor signals and the leveling profile LP2 and only the rather low frequent smoother substrate topology is taken into account, the level sensor spots can be located closer to the exposure slit.

According to the prior art, the level sensor spots may be located in front of the exposure slit, to take into account a certain reaction time or delay time for the leveling. Also, forward extrapolation of the level sensor spots may be used to take this reaction time or delay time into account. Especially on the latest lithographic systems which have a very high scan speed this delay time may correspond with a significant scan distance.

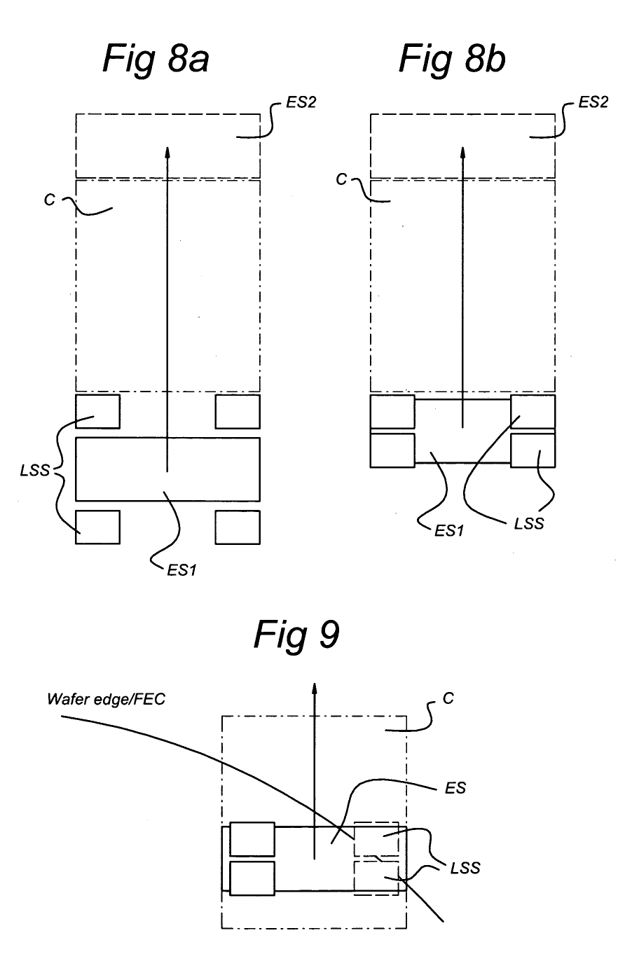

In embodiments, since the high frequent product topology is removed from the level sensor signals, the level sensor spots may be located closer to the exposure slit. This is because prediction of the topology by forward extrapolation of the measurements of the level sensor spots close to the exposure slit becomes more accurate if there is less high frequent content in the measurement signals. Therefore, the length of scans for each exposure can be reduced as explained in FIGS. 8a and 8b below resulting in a higher throughput.

FIG. 8a and 8b both show a target portion C that is scanned by an exposure slit ES from bottom to top according to the orientation depicted in FIGS. 8a and 8b. In both figures the start positions of the exposure slit ES1 and the end position of the exposure slit ES2 are depicted. Further shown are the positions of the level sensor spots LSS, in this example there are four level sensor spots LSS.

In FIG. 8a and 8b, level sensor spots LSS are also shown behind the exposure slit (with respect to the scan direction). These level sensor spots LSS may be used for scans in the opposite direction.

According to FIG. 8a, showing a situation according to the prior art, the level sensor spots LSS are relatively far ahead of the exposure slit ES. Therefore, at the start ES1, the exposure slit ES is relatively far removed from the target portion C. According to FIG. 8b, showing an arrangement according to the present invention, the level sensor spots LSS are relatively close to the exposure slit ES. The situation according to FIG. 8b results in a smaller scan length (indicated with the arrow), resulting in a higher throughput of the system.

An additional merit is explained with reference to FIG. 9. When target portions C near the edge of a substrate W are scanned, level sensor spots LSS need to be switched off (or their readings are to be ignored), as soon as they start measuring outside the substrate W. FIG. 9 shows a target portion C being scanned by an exposure slit ES. The level sensor spots LSS at the right side of the target portion C as shown in FIG. 9 are invalid as they (partially) fall outside the substrate W. Therefore, these level sensor spots LSS are to be switched off.

According to the prior art, switching off level sensor spots resulted in a discontinuity in the determined position and tilt (z, Ry, Ry) of the substrate W. According to the embodiments discussed herein, the discontinuity in the leveling response due to spot switching is smaller. Since the high frequent product topology is effectively removed from the level sensor signals and the leveling profile LP2 and only the rather low frequent smoother substrate topology is taken into account, switching off one or more level sensors spots LSS results in a relatively smaller discontinuity. This also means that in areas where height and/or tilt is extrapolated because there are not enough valid level sensor spots, the extrapolation becomes more accurate. This is because the high frequent topology does not disturb the extrapolation.

As explained above, during exposure previously determined average spot profiles are subtracted from the respective spot readings of the level sensor LS. By doing this, the surface pattern of a substrate resulting from previous exposures and processing actions is ignored during exposure leveling.

### Embodiment 2

According to a further embodiment, again the topology of a number of measurement areas is measured on a first substrate W of a batch of substrates W by performing a number of measurement scans with the level sensor LS, as described above. Based on the performed measurements, information is determined that may be used during the actual leveling during exposure.

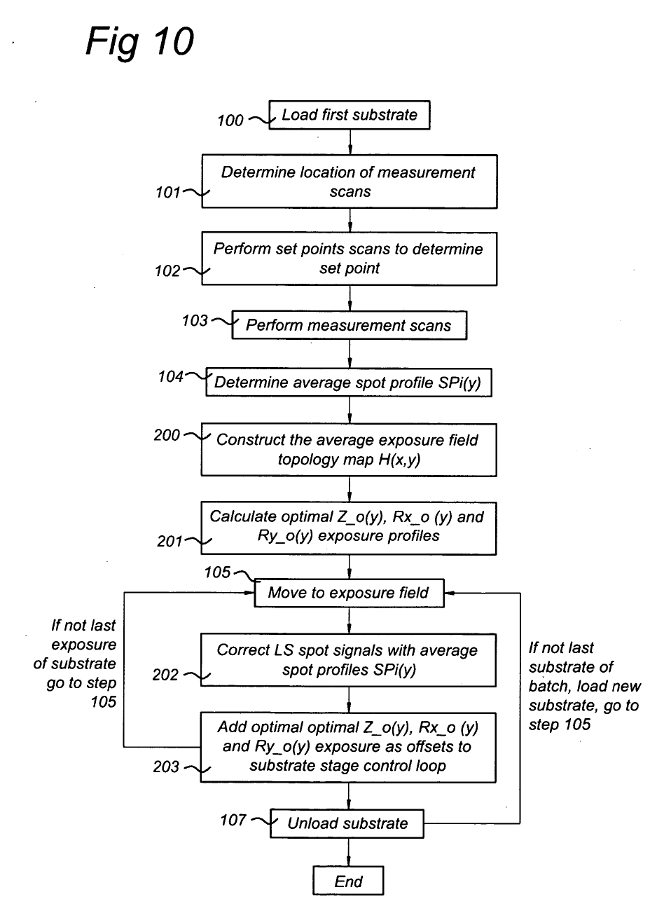

According to this further embodiment, the determined average spot profiles are not ignored during exposure, but instead are used during exposure. In this embodiment of the invention, the leveling response during exposure is a superposition of the on-the-fly levelling response to the underlying substrate topology and an optimal levelling response calculated off-line based on previously measured average spot profiles,as depicted by the flowchart in FIG. 10.

According to such an embodiment, the local topology that is assumed constant for each target portion C is measured before exposure and used during exposure in a feed-forward loop, while the underlying global substrate topology (e.g. due to unflattness of the substrate) is measured during exposure (on-the-fly) and is compensated for using a feed-back loop.

Actions 100 to 104 of FIG. 10 are similar to actions 100 to 104 as described above with reference to FIG. 4.

After action 104, in action 200, the average topology of the average spot profiles SPi(y) are used to compute a three dimensional topology map H(x,y) of an average measurement location, such as an exposure field or target portion C.

The algorithm to compute this three dimensional average topology map H(x, y) uses the relative positions xi,yi of the level sensor spots with respect to the centre of the exposure image slit area. If there are level sensor spots outside the actual exposure area, the signals of these level sensor spots may be folded back into the exposure area of a neighboring exposure field or target portion C that is probed by the spot that has the same product topology.

In an action 201, the average Z_o(y), Rx_o (y) and Ry_o(y) profiles of the movements of the exposure slit image over the H(x,y) map are calculated that minimize the focusing errors on all positions in the exposure field. As already described above, the z-value represents the height of the substrate table WT in a direction substantially perpendicular to the projection beam PB of radiation and the tilts Rx and Ry represent the tilt about an x and y axis, being substantially perpendicular with respect to the z-axis and being substantially perpendicular with respect to each other. These three parameters are expressed as a function of y, being the scan direction of the measurements and exposure.

In the calculation, the exact size of the exposure image slit area and the light intensity distribution within the slit area may be taken into account. Furthermore the usable depth of focus at every position in the field, the maximum speed, acceleration and jerk of the substrate table WT movements are taken into account in the calculation, as will be understood by a skilled person.

After action 201, action 105 is performed, which is similar to action 105 described above with reference to FIG. 4.

Next, in action 202, during exposure, the level sensor signals are corrected for the average topology determined in action 104. In this way the local systematic topology (resulting from previous exposures and processing) is ignored and the global substrate shape may be taken into account. Action 202 is therefore similar to action 106 described above.

The resulting level sensor signals are then used as input for the on-the-fly leveling servo algorithm controlling the actuators 12 controlling the substrate table WT. The servo algorithm (substrate table servo loop) may include various filters to optimize the frequency response of the control loop.

As indicated by additional action 203, at the same moment the average Z_o(y), Rx_o (y) and Ry_o(y) profiles resulting from action 201 are added as offsets to the substrate table WT setpoints in the servo algorithm. The set points (actuator set points) are the Z, Rx, Ry positions of the substrate table WT/substrate stage.

The result of action 202 is that the leveling only responds to the underlying substrate topology variations and not to the higher frequent product topology. However, as a result of action 203, adding the average Z_o(y), Rx_o (y) and Ry_o(y) profiles as offsets to the substrate table servo loop, the product topology is not ignored, but instead, the ideal response to the additional product topology is established.

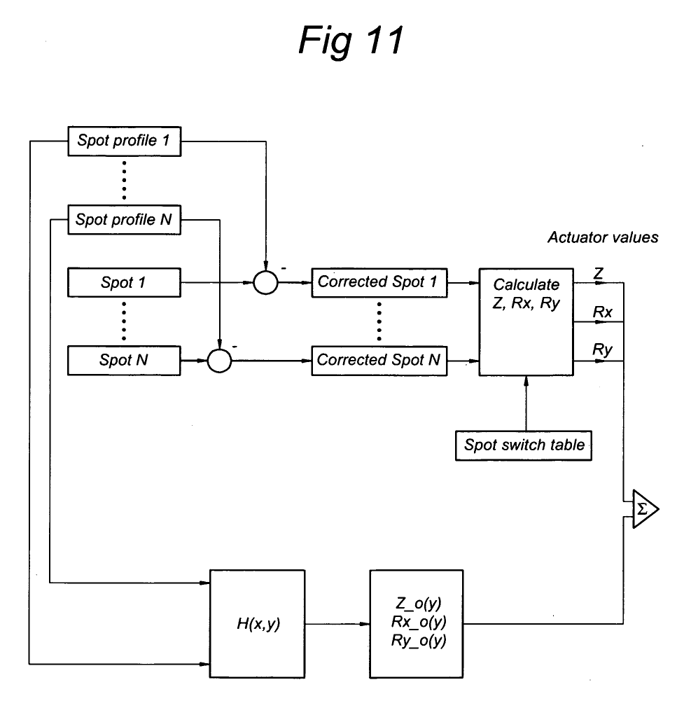

FIG. 11 shows that the N average spot profiles as determined in action 104 are subtracted from the respective N spot readings of the level sensor LS, resulting in N corrected level sensor spot values. The level sensor spot measurements are thus corrected for the average topology and representing the global substrate shape.

Based on these corrected level sensor spot values, an appropriate position and orientation of the substrate table WT is determined, in order to achieve an optimal focus. The appropriate position of the substrate table WT is determined using conventional techniques, known to a skilled person. These optimal position and orientation may be expressed in a z-value, representing the height of the substrate table WT in a direction substantially perpendicular to the projection beam PB of radiation and a tilt Rx and Ry about an x and y axis, being substantially perpendicular with respect to the z-axis and being substantially perpendicular with respect to each other.

FIG. 11 further depicts that the N average spot profiles as determined in action 104 are used to compute the three dimensional topology map H(x,y) of an average measurement location, such as an exposure field or target portion C.

Next, based on the three dimensional topology map H(x, y) the average Z_o(y), Rx_o (y) and Ry_o(y) profiles of the movements of the exposure slit image over the H(x,y) map are calculated that minimize the focusing errors on all positions in the exposure field.

Finally, the average Z_o(y), Rx_o (y) and Ry_o(y) are added to the values for Z, Rx, Ry during exposure.

Thus, according to an embodiment, the position of the substrate table with respect to the patterned radiation beam is adjusted based on the level sensor readings, by computing a position for the substrate table in a height direction being substantially in a direction parallel to the patterned radiation beam, and computing a first and second tilt for the substrate table about a first axis and a second axis, where the first and second axis are substantially perpendicular to the height direction.

According to this second embodiment, the computed position in the height direction and first and second tilt for the substrate table is adjusted based on a previously determined average position in the height direction and a previously determined average first tilt and a previously determined average second tilt as computed based on the previously determined average level sensor readings.

According to an embodiment, there is provided a method comprising computing an average position for the substrate table in a height direction and an average first tilt about a first axis and an average second tilt about a second axis, computed based on the previously determined average level sensor readings, where the first and second axis are substantially perpendicular to the height direction.

An additional advantage of this embodiment is that a relatively good leveling response may be achieved on product topology with an on-the-fly leveling system. The resulting leveling behavior will be a superposition of the default on-the-fly leveling-behavior on the underlying bare substrate, and the off-line calculated best leveling profiles for the device topology. The almost ideal response of the described embodiment does not suffer from the usual delays occurring on on-the-fly leveling systems that are noticeable as leveling differences between up and down scans over the same product topology. As a result focusing errors are smaller, process latitude increases and smaller device structures may be printed.

### Embodiment 3

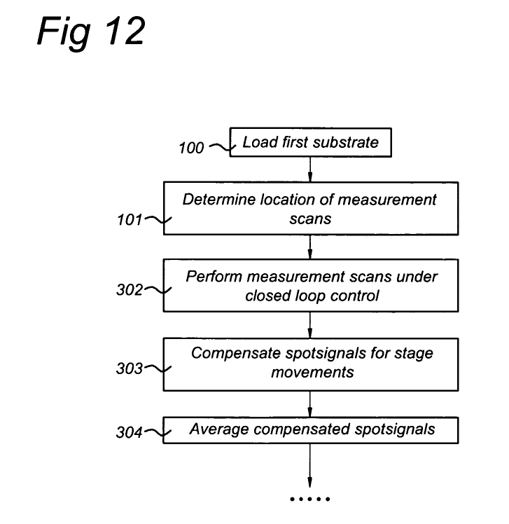

According to a further embodiment the average spot profile SPi(y) as for instance determined in action 104 explained above, is acquired according to a flowchart shown in FIG. 12.

Actions 100 and 101 in FIG. 12 may be similar to actions 100 and 101 as described above with reference to FIG. 4.

In an action 302, measurement scans are performed under closed loop control. In this action 302, during the measurement scan, the control device 6 controls the substrate table WT via actuators 12, such that the substrate surface covered by the level sensor spots is in the focal plane. Level sensor spot signals Si(y) as a function of the y scan position relative to the center of the measurement area or target portion C, and substrate table positions Z(y), Rx(y) and Ry(y) movements as measured by position sensors 14, are stored in memory 10 during the scans.

In a next action 303, compensated level sensor spot signals Si,c(y) for all measurement scans are calculated by correcting the measured level sensor spot signals Si(y) for the substrate table positions Z(y), Rx(y) and Ry(y). This is done in such a way that the compensated level sensor spots Si,c(y) are the level sensor spot signals as would be measured in case substrate height Zw(y) and tilts Rxw(y) and Ryw(y) at the location of the exposure area would have been kept constant during a exposure scan.

In a next action 304, the compensated level sensor spot signals Si,c(y) are averaged over all measurement scans. The average is computed for each level sensor spot i and each grid point. The result of action 304 is substantially the same as action of 104 as described above. The advantage of this embodiment compared to actions 100 to 104, as described above (see e.g. FIG. 4), is a throughput gain because the set point scans may be omitted.

In case the substrate table WT as a result of inertia is a value of δz too high, also the level sensor signals are δz higher. The compensated level sensor signals are independent of the exact movements of the substrate table WT.

So, according to this embodiment, the level sensor scans are performed under closed loop control, where the substrate table is controlled according to controlled substrate table positions, such that the substrate covered by the level sensor is substantially in a focal plane of a projection system, and compensated level sensor readings are calculated by correcting the measured level sensor readings for the controlled substrate table positions.

In the above embodiments, so called average spot profiles SPi(y) are calculated. It will be understood that all kind of ways to calculate average spot profiles SPi(y) may be used. For instance, the average spot profiles SPi(y) may also be calculated using weighing factors for the different components of which the average is calculated.

It will be understood that for all embodiments described, the lithographic apparatus may comprise a control device with a processor and a memory, actuators and position sensors, the actuators are arranged to position the substrate table, and the position sensors are arranged to measure the actual position of the substrate table, and wherein the processor is arranged to receive information from position sensors and control actuators. The processor may be arranged to execute any one of the embodiments described.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

Although specific reference may have been made above to the use of embodiments of the invention in the context of optical lithography, it will be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

The term “lens”, where the context allows, may refer to any one or combination of various types of optical components, including refractive, reflective, magnetic, electromagnetic and electrostatic optical components.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

1. A method for imaging a pattern onto a target portion of a substrate, the method comprising
providing a projection system configured to project a patterned radiation beam onto a target portion of a substrate,
providing a substrate positioned on a substrate table, the substrate table being arranged to be positioned with respect to the radiation beam,
providing a level sensor arranged to provide level sensor readings being a measure of topology of the substrate at one or more positions within the target portion;
providing level sensor readings by scanning the target portion with the level sensor, while synchronously imaging the pattern onto the target portion by scanning the target portion of the substrate with the patterned radiation beam, while positioning the substrate table with respect to the radiation beam based on the level sensor readings, wherein
the level sensor readings are adjusted based on previously determined average level sensor readings.

2. The method according to claim 1, wherein the substrate table is positioned with respect to the radiation beam such that the substrate is substantially in a focal plane of the projection system.

3. The method according to claim 1, wherein the level sensor readings are adjusted by subtracting the previously determined average level sensor readings from the level sensor readings.

4. The method according to claim 1, wherein the position of the substrate table with respect to the patterned radiation beam is adjusted based on the level sensor readings, by computing a position for the substrate table in a height direction being substantially in a direction parallel to the patterned radiation beam, and computing a first and second tilt for the substrate table about a first axis and a second axis, where the first and second axis are substantially perpendicular to the height direction.

5. The method according to claim 4, wherein the computed position of the substrate table in the height direction and first and second tilt for the substrate table is adjusted based on a previously determined average position in the height direction and a previously determined average first tilt and a previously determined average second tilt as computed based on the previously determined average level sensor readings.

6. The method according to claim 1, wherein the scanning the target portion with the patterned beam of radiation takes place along a first direction, wherein the previously determined average level sensor readings comprise average spot profiles of the topology of the substrate along a path substantially in the first direction.

7. The method according to claim 1, wherein the adjustment of the level sensor readings based on previously determined average level sensor readings is done by using previously determined average level sensor readings valid for a position within the target portion that is close to a position where the level sensor readings are valid.

8. The method according to claim 7, wherein the adjustment of the level sensor readings based on previously determined average level sensor readings is done by using an interpolation of at least two previously determined average level sensor readings.

9. A method for determining average level sensor readings, comprising:
providing at least one substrate positioned on a substrate table,
providing a level sensor arranged to provide level sensor readings being a measure of the topology of the substrate at one or more positions within a measurement area on the at least one substrate,
providing level sensor readings by scanning at least two measurement areas with the level sensor; and
computing average level sensor readings by averaging level sensor readings from corresponding relative positions within different measurement areas.

10. The method according to claim 9, wherein the at least two measurement areas that are scanned with the level sensor are chosen based on one or more of the group of criteria comprising:
(1) the at least two measurement areas match the layout of target portions on the substrate,
(2) all level sensor readings are valid within the at least two measurement areas,
(3) the at least two measurement areas are different measurement areas, and
(4) the at least two measurement areas are located close to the centre of the substrate.

11. The method according to claim 9, wherein before providing level sensor readings by scanning a measurement area with the level sensor, set points are determined by performing set point scans.

12. The method according to claim 9, further comprising computing an average position for the substrate table in a height direction and an average first tilt about a first axis and an average second tilt about a second axis, based on the previously determined average level sensor readings, wherein the first and second axis are substantially perpendicular to the height direction.

13. The method according to claim 9, wherein the level sensor scans are performed under closed loop control, wherein the substrate table is controlled according to controlled substrate table positions, such that the substrate covered by the level sensor is substantially in a focal plane of a projection system, and wherein compensated level sensor readings are calculated by correcting the measured level sensor readings for the controlled substrate table positions.

14. A lithographic apparatus for imaging a pattern onto a target portion of a substrate, the lithographic apparatus comprising:
a projection system configured to project a patterned radiation beam onto a target portion of a substrate,
a substrate table constructed to hold the substrate, the substrate table being arranged to be positioned with respect to the radiation beam, and
a level sensor arranged to provide level sensor readings being a measure of the topology of the substrate at one or more positions within the target portion, the system being arranged to:
provide level sensor readings by scanning the target portion with the level sensor, while synchronously imaging the pattern onto the target portion by scanning the target portion of the substrate with the patterned radiation beam, while positioning the substrate table with respect to the projection beam based on the level sensor readings, where
the level sensor readings are adjusted based on previously determined average level sensor readings.

15. A lithographic apparatus according to claim 14, further comprising a control device having a processor and a memory, actuators and position sensors, the actuators e arranged to position the substrate table, and the position sensors arranged to measure the actual position of the substrate table, and wherein the processor is arranged to receive information from the position sensors and control actuators.

16. A lithographic apparatus according to claim 15, in which the processor is arranged to execute any one of the method claims 1-13.

17. The lithographic apparatus according to claim 14, wherein the level sensor readings are adjusted by subtracting previously determined average level sensor readings from the level sensor readings.

18. A lithographic apparatus comprising:
a substrate table constructed to hold a substrate; and
a level sensor arranged to provide level sensor readings being a measure of the topology of the substrate at least at one position within a measurement area on the substrate, the lithographic apparatus further configured to:
provide level sensor readings by scanning at least two measurement areas with the level sensor, and
compute average level sensor readings by averaging the level sensor readings from corresponding relative positions within different measurement areas.
